(19) United States
(12) Patent Application Publication
(10) Pub. No.: US 2015/0213743 A1
(43) Pub. Date: Jul. 30, 2015

(54) SYSTEM AND METHOD FOR PROJECTING IMAGE

(71) Applicant: LG INNOTEK CO., LTD., Seoul (KR)

(72) Inventor: Won Suk Chung, Seoul (KR)

(73) Assignee: LG INNOTEK CO., LTD., Seoul (KR)

(21) Appl. No.: 14/421,962

(22) PCT Filed: Jul. 30, 2013
(86) PCT No.: PCT/KR2013/006853

§ 371 Date: Feb. 16, 2015

(30) Foreign Application Priority Data
Aug. 16, 2012 (KR) 10-2012-0089325
Aug. 16, 2012 (KR) 10-2012-0089326

(51) Int. Cl. G09G 3/00; H05B 37/02; H04N 5/74

(52) U.S. Cl. CPC G09G 3/002; H04N 5/74; H05B 37/02; G09G 2360/144; G09G 2360/145

(57) ABSTRACT

Disclosed are a system and a method of projecting an image. An image projecting device projects an image signal. A display device measures a present illuminance, transmits the present illuminance, and adjusts the dimming according to the present illuminance. In the system for projecting the image, the surrounding illuminance is easily controlled.

### TECHNICAL FIELD

The embodiment relates to a system and a method of projecting an image.

### BACKGROUND ART

In general, a system for projecting an image includes a screen and an image projecting device to project an image onto the screen by enlarging the image. In this case, the image projecting device projects the image with preset brightness. When the image projecting device is driven, the definition of the image on the screen may be determined depending on surrounding illuminance. In this case, as the surrounding illuminance is lowered, the image on the screen may be more clearly displayed. In addition, the surrounding illuminance may be determined by the brightness of an image or the dimming of a lighting device.

Meanwhile, generally, a plurality of lighting devices are installed at an interior. In addition, the lighting devices are turned on or off by switches connected thereto through cables. In this case, the lighting devices may be turned on or off at once, or may be individually turned on or off.

However, a user feels inconvenient when accessing the switch in order to drive the system for projecting an image. In addition, the fine adjustment of the surrounding illuminance of the screen is difficult.

### DISCLOSURE OF INVENTION

### Technical Problem

Accordingly, an object of the present invention is to provide a system and a method of projecting an image, capable of easily controlling the surrounding illuminance. In other words, the system and the method of projecting the image are to automatically control the brightness of the image or the dimming of the lighting device.

### Solution to Problem

According to the embodiment, there is provided a system for projecting an image. The system includes an image projecting device to project an image signal, a display device including a screen unit to display the image signal thereon, an illuminance sensor to measure a present illuminance, and a first communication unit to transmit the present illuminance, and a lighting device to adjust dimming according to the present illuminance.

According to the embodiment, there is provided a method of projecting an image. The method includes projecting an image signal on a display device by an image projecting device, measuring a present illuminance by the display device, transmitting the present illuminance by the display device, and adjusting dimming according to the present illuminance by a lighting device.

### Advantageous Effects of Invention

According to the system and the method of projecting the image of the present invention, the surrounding illuminance can be easily controlled. In other words, the lighting device can adjust the dimming corresponding to present illuminance, or can adjust the brightness of the image. Accordingly, in the system for projecting the image, the surrounding illuminance can be varied depending on the dimming of the image projecting device or the brightness of the image of the image projecting device. Accordingly, the fine adjustment of the surrounding illuminance is possible in the system for projecting the image.

### BRIEF DESCRIPTION OF DRAWINGS

FIG. 1 is a block diagram showing the structure of a system for projecting an image according to the embodiments.

FIG. 2 is a block diagram showing the internal structure of an image projecting device according to the embodiments.

FIG. 3 is a block diagram showing the internal structure of a display device according to the embodiments.

FIG. 4 is a block diagram showing the internal structure of a lighting device according to the embodiments.

FIG. 5 is a block diagram showing the internal structure of a lighting gateway according to the embodiments.

FIG. 6 is a flowchart showing the signal flow of a system for projecting an image according to the first embodiment.

FIG. 7 is a flowchart showing the signal flow of a system for projecting an image according to the second embodiment.

FIG. 8 is a flowchart showing the operating procedure of an image projecting device according to the first and second embodiments.

FIG. 9 is a flowchart showing the operating procedure of a display device according to the first and second embodiments.

FIG. 10 is a flowchart showing the operating procedure of a lighting device according to the first and second embodiments.

FIG. 11 is a flowchart showing the operating procedure of a lighting gateway according to the first and second embodiments.

FIG. 12 is a flowchart showing the signal flow of a system for projecting an image according to the third embodiment.

FIG. 13 is a flowchart showing the signal flow of a system for projecting an image according to the fourth embodiment.

FIG. 14 is a flowchart showing the operating procedure of an image projecting device according to the third and fourth embodiments.

FIG. 15 is a flowchart showing the operating procedure of a display device according to the third and fourth embodiments.

FIG. 16 is a flowchart showing the operating procedure of a lighting device according to the third and fourth embodiments.

FIG. 17 is a flowchart showing the operating procedure of a lighting gateway according to the third and fourth embodiments.

### MODE FOR THE INVENTION

Hereinafter, the embodiments will be described in more detail with reference to accompanying drawings. In the following description, the same components will be assigned with the same reference numerals. If it is determined that description about well known functions or configurations may make the subject matter of the embodiments unclear, the details thereof will be omitted.

In the following description, the term “image brightness” refers to the quantity of light output from an image projecting device. In other words, the image brightness represents the quantity of light included in an image. In this case, as the image brightness represents a stronger intensity under a dark environment, the definition of the image may be more increased. In this case, the adjustment down of the image brightness is to reduce the quantity of light. Therefore, as the image brightness is adjusted down, the surrounding illuminance may be lowered. In other words, the surrounding environment may become darken. In addition, the adjustment up of the image brightness is to increase the quantity of light. Therefore, as the image brightness is adjusted up, the surrounding illuminance may be increased. In other words, as the surrounding environment may be brightened. In addition, the maintaining of the image brightness represents the maintaining of the quantity of light. Accordingly, as the image brightness is maintained, the surrounding illuminance may be maintained. In other words, the brightness of the surrounding environment may be maintained.

In addition, the term “dimming” refers to luminous flux output from the lighting device. The adjustment down of the dimming is to reduce the luminous flux from the lighting device. In this case, as the dimming is adjusted down, the surrounding illuminance may be lowered. In other words, the surrounding illuminance may be darkened. In addition, the adjustment up of the dimming is to increase the flux of the lighting device. In this case, as the dimming is adjusted up, the surrounding illuminance may be heightened. In other words, the surrounding environment may be brightened. In addition, the maintaining the dimming is to maintain the flux of the lighting device. In this case, as the dimming is maintained, the surrounding illuminance may be maintained. In other words, the brightness of the surrounding area may be maintained.

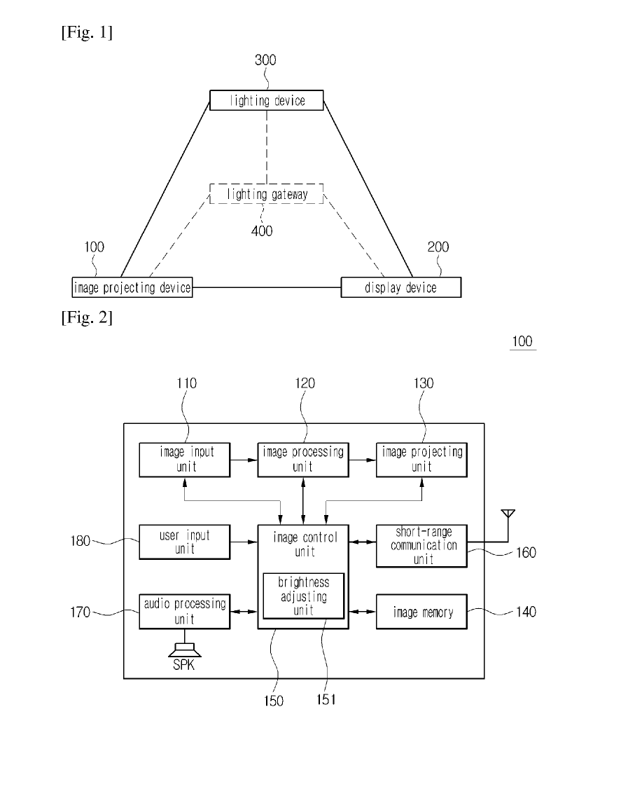

FIG. 1 is a block diagram showing the structure of a system for projecting an image according to the embodiments.

Referring to FIG. 1, according to the embodiments, the system for projecting the image includes an image projecting device 100, a display device 200, and a lighting device 300. The image projecting device 100 and the display device 200 execute an image display mode. The image projecting device 100 projects an image signal, and the display device 200 displays the image signal. The lighting device 300 executes an automatic control mode. In other words, when the image projecting device 100 and the display device 200 execute an image display mode, the lighting device 300 executes an automatic control mode. In this case, the lighting device 300 may adjust dimming. Further, in the system for projecting the image, at least two of the image projecting device 100, the display device 200, and the lighting device 300 may make communication with each other.

Meanwhile, the system for projecting the image may further include a lighting gateway 400. The lighting gateway 400 may relay the communication between at least two of the image projecting device 100, the display device 200 and the lighting device 300.

FIG. 2 is a block diagram showing the internal structure of the image projecting device according to the embodiments.

Referring to FIG. 2, according to the embodiments, the image projecting device 100 includes an image input unit 110, an image processing unit 120, an image projecting unit 130, an image memory 140, an image control unit 150, a short range communication unit 160, an audio processing unit 170, and an user input unit 180.

The image input unit 110 inputs an image signal. In this case, the image input unit 110 is connected to an external device (not shown). In this case, the external device includes a TV (TeleVision), a VCR (Video Cassette Recorder), a DVD (Digital Versatile Disc) player, a PC (Personal Computer), and a camcorder. In addition, the image input unit 110 receives an image signal from the external device and inputs the image.

The image processing unit 120 processes an image signal. In this case, the image processing unit 120 generates screen data. In this case, the image processing unit 120 processes the image signal in the unit of a frame.

The image projecting unit 130 projects the image signal. In this case, the image projecting unit 130 outputs the screen data corresponding to the image signal. In this case, the image projecting unit 130 enlarges the image signal to an image signal having a preset size. In addition, the image projecting unit 130 projects the image signal with preset image brightness. In this case, the image projecting unit 130 is driven according to the current and the voltage applied thereto to output light in quantity corresponding to the image brightness.

The image memory 140 stores programs to control a general operation of the image projecting device 100. In this case, the image memory 140 stores programs to execute the image display mode. In this case, the image memory 140 may store programs to adjust the image brightness. In addition, the image memory 140 stores data generated during the execution of the programs. In this case, the image memory 140 may store the preset image brightness.

The image control unit 150 controls the overall operation of the image projecting device 100. The image control unit 150 executes the image display mode. In this case, at the image display mode, the image control unit 150 performs a control operation to project the image signal with the present image brightness.

In addition, the image control unit 150 includes a brightness adjusting unit 151. The brightness adjusting unit 151 adjusts the preset image brightness. For example, the brightness adjusting unit 151 adjusts the image brightness based on the preset image brightness to change image brightness to be set. In this case, the brightness adjusting unit 151 may adjust up or down the image brightness, or may maintain the image brightness at a present level. To this end, the brightness adjusting unit 151 may adjust the quantity of light to be output together with the image signal. In addition, the brightness adjusting unit 151 may adjust current or voltage applied to the image projecting unit 130.

In addition, when the image display mode is executed, the image control unit 150 executes the image display mode of the display device 200. In this case, the image control unit 150 may turn on the display device 200. In addition, when the image display mode is terminated, the image control unit 150 terminates the image display mode of the display device 200. In this case, the image control unit 150 may turn off display device 200.

The short range communication unit 160 makes short-range communication in the image projecting device 100. In this case, the short range communication unit 160 may make communication with at least one of the display device 200, the lighting device 300 and the lighting gateway 400 under the control of the image control unit 150.

The audio processing unit 170 outputs an audio signal corresponding to the image signal. In this case, the audio processing unit 170 reproduces the audio signal output from the image control unit 150 through a speaker (SPK).

The user input unit 180 includes keys to require the execution of the image display mode in the image projecting device 100.

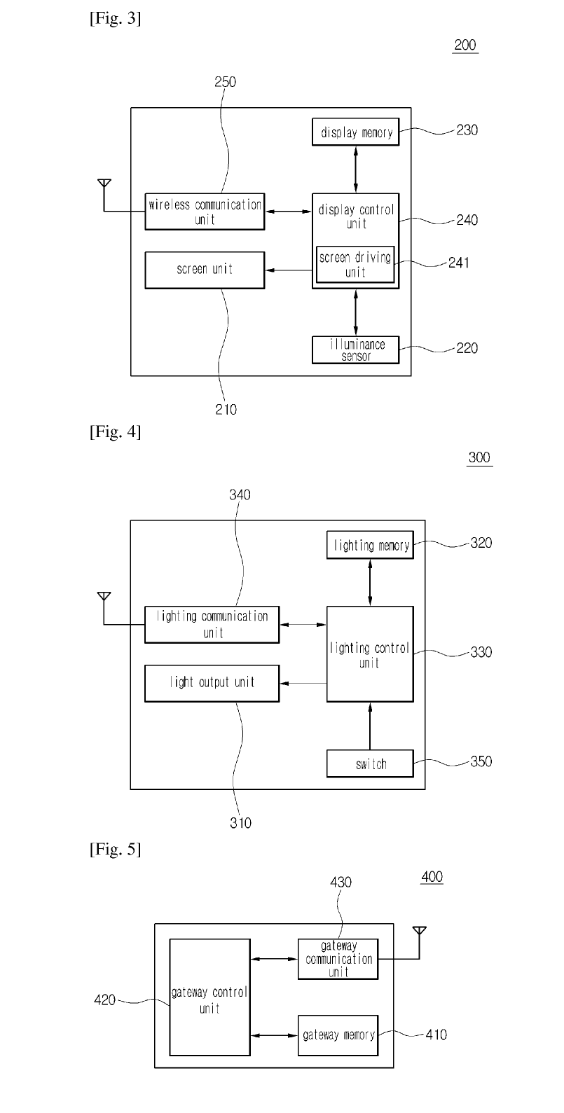

FIG. 3 is a block diagram showing the internal structure of the display device according to the embodiments.

Referring to FIG. 3, according to the embodiments, the display device 200 includes a screen unit 210, an illuminance sensor 220, a display memory 230, a display control unit 240, and a wireless communication unit 250.

Referring to FIG. 3, according to the embodiments, the screen unit 210 reflects the image signal from the image projecting device 100. Accordingly, the image signal is displayed on the screen unit 210.

The illuminance sensor 220 measures present illuminance. In other words, the illuminance sensor 220 measures the present illuminance by detecting the speed of light incident thereon at a present position.

The display memory 230 stores programs to control the general operation of the display device 200. In this case, the display memory 230 stores programs to execute the image display mode. In addition, the display memory 230 stores data generated during the execution of the programs.

The display control unit 240 controls the overall operation of the display device 200. The display control unit 240 executes the image display mode. In this case, at the image display mode, the display control unit 240 displays the image signal from the image projecting device 100 on the screen unit 210. In addition, the display control unit 240 measures the present illuminance by controlling the illuminance sensor 220. In this case, the display control unit 240 may periodically and repeatedly measure the present illuminance.

The display control unit 240 executes an image mode under the control of the image projecting device 100. In this case, the display control unit 240 may be turned on or off under the control of the image projecting device 100. In addition, the display control unit 240 includes a screen driving unit 241. The screen driving unit 241 drives or terminates the screen driving unit 241 according to the request of the image projecting device 100. In this case, if the image projecting device 100 requests the execution of the image display mode, the screen driving unit 241 rolls down the screen unit 210. In addition, if the image projecting device 100 requests the termination of the image display mode, the screen driving unit 241 rolls up the screen unit 210.

The wireless communication unit 250 makes short-range communication in the display device 200. In this case, the wireless communication unit 250 may make communication with at least one of the image projecting device 100, the lighting device 300 and the lighting gateway 400 under the control of the display control unit 240.

FIG. 4 is a block diagram showing the internal structure of the lighting device according to the embodiments.

Referring to FIG. 4, according to the embodiments, the lighting device 300 includes a light output unit 310, a lighting memory 320, a lighting control unit 320, a lighting communication unit 340, and a switch 350.

The light output unit 310 generates light. In this case, the light output unit 310 is driven according to current and voltage applied thereto to generate light. In this case, the light output unit 310 outputs light by performing a blinking operation. In other words, the light output unit 310 repeatedly performs an operation of cutting off light without outputting light for light cut-off period of time after outputting light for light output period of time.

In addition, the light output unit 310 may include a plurality of light emitting diodes (LEDs).

The lighting memory 320 stores programs to control the general operation of the lighting device 300. In this case, the lighting memory 320 may store programs to execute an automatic control mode. In addition, the lighting memory 320 stores data generated during the execution of the programs. In this case, the lighting memory 320 may store the light output period of time and the light cut-off period of time for the light output unit 310.

The lighting control unit 320 controls the overall operation of the lighting device 300. The lighting control unit 320 executes the automatic control mode. In this case, at the automatic control mode, the lighting control unit 320 may adjust the dimming. In this case, the lighting control unit 320 adjusts up or down the dimming, or maintains the dimming at a present level. To this end, the lighting control unit 320 may adjust the light output period of time and the light cut-off period of time for the light output unit 310. In addition, the lighting control unit 320 may adjust current or voltage applied to the light output unit 310.

The lighting communication unit 340 makes short range communication in the lighting device 300. In this case, the lighting communication unit 340 may make communication with at least one of the image projecting device 100, the display device 200, or the lighting gateway 400 under the control of the lighting control unit 320.

The switch 350 inputs a request to turn on or off the lighting device 300.

FIG. 5 is a block diagram showing the internal structure of a lighting gateway according to the embodiments.

Referring to FIG. 5, according to the embodiments, the lighting gateway 400 includes a gateway memory 410, a gateway control unit 420, and a gateway communication unit 430.

The gateway memory 410 stores programs to control a general operation of the lighting gateway 400. In this case, the gateway memory 410 may store programs to relay communication in the system for projecting the image. In addition, the gateway memory 410 stores data generated during the execution of the programs.

The gateway control unit 420 controls the overall operation of the lighting gateway 400. In this case, the gateway control unit 420 relays communication in the system for projecting the image. In other words, the gate control unit 420 may relay the communication between at least two of the image projecting device 100, the display device 200 and the lighting device 300.

The gateway communication unit 430 makes short-range communication in the lighting gateway 400. In this case, the gateway communication unit 430 may make communication with at least one of the image projecting device 100, the display device 200 and the lighting device 300 under the control of the gateway control unit 420.

FIG. 6 is a flowchart showing the signal flow of the system for projecting the image according to the first embodiment.

Referring to FIG. 6, according to the present embodiments, the image projecting device 100 projects an image signal on the display device 200 in step 511. In this case, as the display device 200 reflects the image signal, the image signal is displayed onto the display device 200. In addition, the display device 200 measures present illuminance in step 513. Further, the display device 200 transmits the present illuminance to the lighting device 103 in step 515. Thereafter, the lighting device 103 adjusts the dimming according to the present illuminance in step 517. Accordingly, the present illuminance is changed in the system for projecting the image.

In this case, the display device 200 and the lighting device 300 may make communication with each other through a short-range communication technology. In this case, the short-range communication technology includes Bluetooth, Zigbee, WiBro, WiMax, Wireless Local area Network (Wireless LAN), and an infrared communication technology.

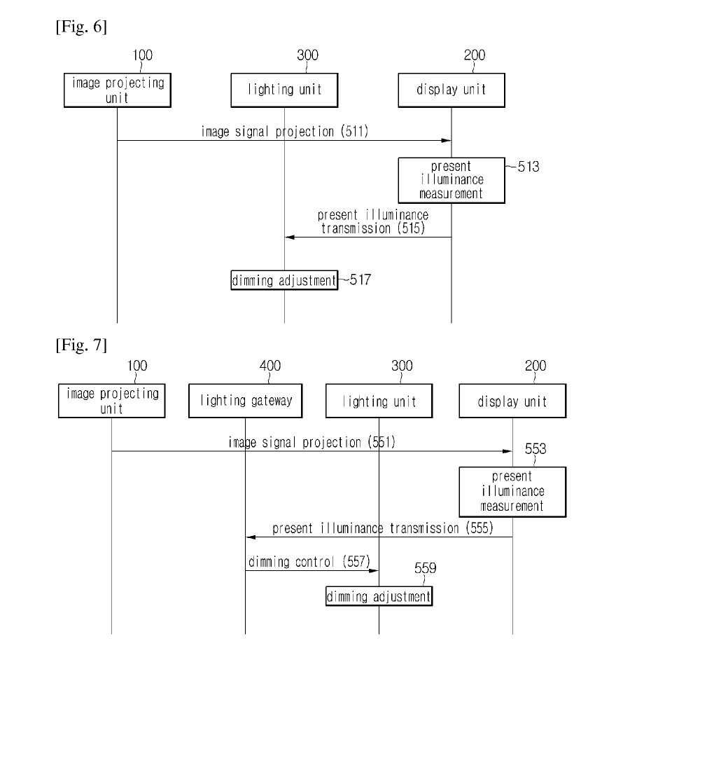

FIG. 7 is a flowchart showing the signal flow of the system for projecting the image according to the second embodiment.

Referring to FIG. 7, according to the present embodiments, the image projecting device 100 projects an image signal onto the display device 200 in step 551. In this case, as the display device 200 reflects the image signal, the image signal is displayed on the display device 200. In addition, the display device 200 measures present illuminance in step 513. Further, the display device 200 transmits present illuminance to the lighting gateway 400 in step 515. Thereafter, the lighting gateway 400 controls the dimming of the lighting device 300 according to the present illuminance in step 557. Accordingly, the lighting device 300 adjusts the dimming under the control of the lighting gateway 400 in step 559. Therefore, the present illuminance is changed in the system for projecting the image.

In this case, the display device 200, the lighting device 300, and the lighting gateway 400 may make communication with each other through a short-range communication technology. In this case, the short-range communication technology includes Bluetooth, Zigbee, WiBro, WiMax, Wireless Local area Network (Wireless LAN), and an infrared communication technology.

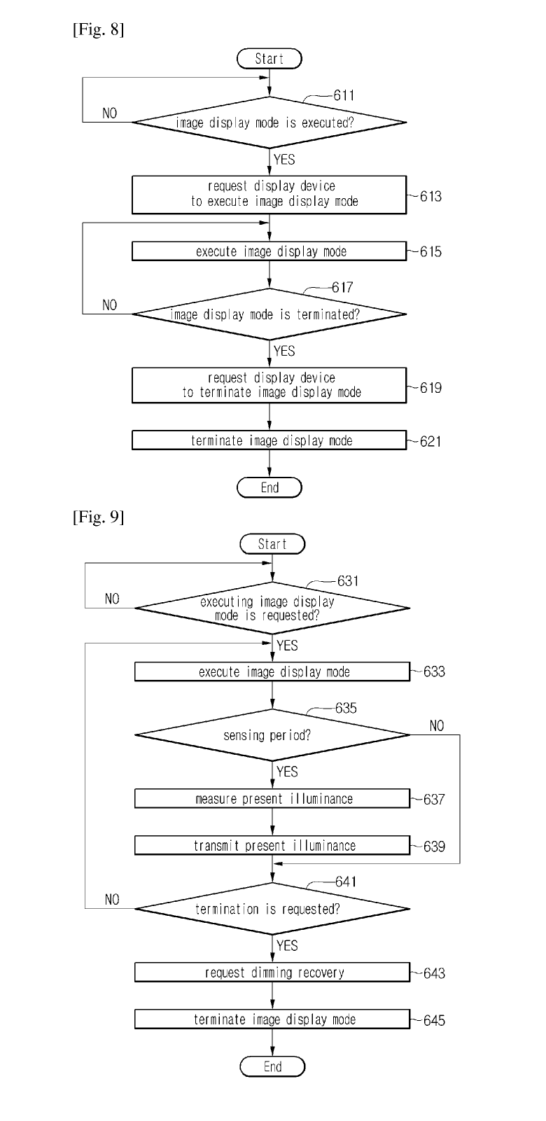

FIG. 8 is a flowchart showing the operating procedure of the image projecting device according to the first and second embodiments.

Referring to FIG. 8, according to the present embodiments, the operating procedure of the image projecting device 100 starts from that the image control unit 150 detects the request for the execution of the image display mode in step 611. In this case, if the execution of the image display mode is requested through the user input unit 180, the image control unit 150 detects the execution request of the image display mode. In this case, the image control unit 150 requests the display device 200 to execute the image display mode in step 613. In this case, the image control unit 150 may request the display device 200 to execute the image display mode through the short range communication unit 160. In addition, the image control unit 150 executes the image display mode in step 615. In this case, the image control unit 150 receives the image signal from an external device and processes the image signal. In addition, the image control unit 150 projects the image signal onto the display device 200.

Next, if the termination of the image display mode is requested during the execution of the image display mode, the image control unit 150 detects the termination of the image display mode in step 617. If the user input unit 180 requests the termination of the image display mode, the image control unit 150 may detect the request. Further, if the image signal is not input into the image input unit 110, the image control unit 150 may determine this as the request for the termination of the image display mode. In this case, the image control unit 150 requests the display device 200 to terminate the image display mode in step 619. The image control unit 150 may request the display device 200 to terminate the image display mode through the short range communication unit 160. In addition, the image control unit 150 terminates the operating procedure of the image projecting device 100 by terminating the image projecting device 100 in step 621.

FIG. 9 is a flowchart showing the operating procedure of the display device according to the first and second embodiments.

Referring to FIG. 9, according to the present embodiments, the operating procedure of the display device 200 starts from that the display control unit 240 detects the request for the execution of the image display mode in step 631. In this case, if the execution of the image display mode is requested from the image projecting device 100, the display control unit 240 detects the execution request of the image display mode. In addition, if the execution of the image display mode is requested through the wireless communication unit 250, the display control unit 240 detects the execution of the image display mode. In this case, the display control unit 240 executes the image display mode in step 633. In this case, the display control unit 240 displays the image signal of the image projecting device 100 on the screen unit 210.

Subsequently, if a sensing period arrives, the display control unit 240 detects the arrival of the sensing period in step 635. In this case, the sensing period may be previously stored in the display memory 230. In addition, the sensing period represents a predetermined period of time periodically occurring from a time point of executing the image display mode. In this case, the display control unit 240 measures the present illuminance in step 637. The display control unit 240 controls the illuminance sensor 220 to measure the present illuminance. In this case, the display control unit 240 transmits the present illuminance in step 639. The display control unit 240 transmits the present illuminance to the lighting device 300 or the lighting gateway 400. The display control unit 240 may transmit the present illuminance through the wireless communication unit 250.

If the termination of the image display mode is requested, the display control unit 240 detects the termination of the image display mode in step 641, and requests the dimming recovery in step 643. In this case, the display control unit 240 requests the lighting device 300 or the lighting gateway 400 for the dimming recovery. The display control unit 240 may request the dimming recovery through the wireless communication unit 250. The display control unit 240 terminates the image display mode in step 645 to terminate the operating procedure of the display device 200.

Meanwhile, if the request for the termination of the image display mode is not detected in step 641, the display control unit 240 may repeat step 633 to step 641. In other words, the display control unit 240 may repeat step 633 to 641 until the request for the termination of the image display mode is detected in step 641.

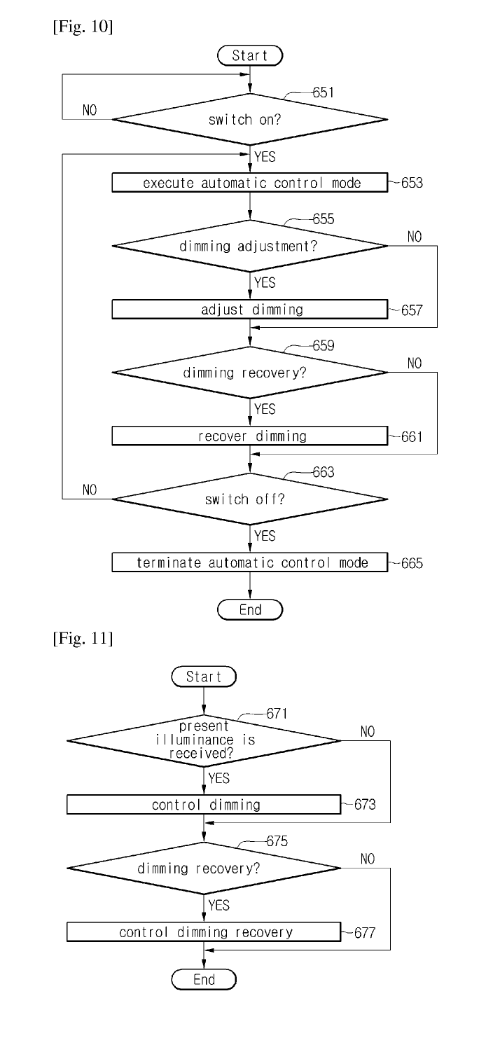

FIG. 10 is a flowchart showing the operating procedure of the lighting device according to the first and second embodiments.

Referring to FIG. 10, according to the present embodiments, the operating procedure of the lighting device 300 starts from that the lighting control unit 320 detects the on-state of the switch 155 in step 651. In other words, if the switch 155 is turned on, the lighting control unit 320 detects the on-state of the switch 155. In this case, the lighting control unit 320 executes the automatic control mode in step 653. The lighting control unit 320 may activate the lighting communication unit 340.

Next, the lighting control unit 320 determines the adjustment state of the dimming in step 655. In this case, if the lighting control unit 320 receives the present illuminance from the display device 200, the lighting control unit 320 may determine the adjustment state of the dimming according to the present illuminance. In addition, if the adjustment of the dimming is requested from the lighting gateway 400, the lighting control unit 320 may determine the adjustment state of the dimming. In this case, if the present illuminance is received or the adjustment of the dimming is requested through the lighting communication unit 340, the lighting control unit 320 may detect the reception of the present illuminance or the request for the adjustment of the dimming.

Next, if the lighting control unit 320 makes determination that the dimming must be adjusted in step 655, the lighting control unit 320 controls the dimming in step 657. In this case, the lighting control unit 320 may adjust the dimming according to the present illuminance. In other words, the lighting control unit 320 may compare the present illuminance with previously-stored reference illuminance. In this case, the reference illuminance may be previously stored in the lighting memory 320. In addition, the lighting control unit 320 may control the dimming under the control of the lighting gateway 400. In other words, the lighting control unit 320 may control the dimming corresponding to the request form the lighting gateway 400. In addition, the lighting control unit 320 adjusts up or down the dimming, or maintains the dimming at a present level. To this end, lighting control unit 320 may adjust the light output period of time of the light output unit 310 and the light cut-off period of time of the light output unit 310. In addition, the lighting control unit 320 may adjust current or voltage applied to the light output unit 310.

For example, if the present illuminance exceeds the reference illuminance, the lighting control unit 320 may adjust down the dimming. To this end, the lighting control unit 320 may reduce the light output period of time of the light output unit 310. In addition, the lighting control unit 320 may reduce current or voltage applied to the light output unit 310. Meanwhile, if the present illuminance is less than the reference illuminance, the lighting control unit 320 may adjust up the dimming. To this end, the lighting control unit 320 may increase the light output period of time of the light output unit 310. In addition, the lighting control unit 320 may increase the current or the voltage applied to the light output unit 310. Meanwhile, if the present illuminance is equal to the reference illuminance, the lighting control unit 320 may maintain the dimming at the present illuminance. In other words, the lighting control unit 320 may maintain the light output period of time of the light output unit 310. In addition, the lighting control unit 320 may maintain the current or the voltage applied to the light output unit 310.

Thereafter, the lighting control unit 320 determines the recovery state of the dimming in step 659. In this case, if the dimming recovery is requested from the display device 200 or the lighting gateway 400, the lighting control unit 320 may determine the recovery state of the dimming. In this case, if the dimming recovery is requested through the lighting communication unit 340, the lighting control unit 320 may detect the request for the dimming recovery.

Subsequently, if the lighting control unit 320 makes determination that the dimming must be recovered in step 659, the lighting control unit 320 recovers the dimming in step 661. In this case, the lighting control unit 320 recovers the dimming corresponding to the request for the display device 200 or the lighting gateway 400. In this case, the lighting control unit 320 may recover the dimming at the same point as the time point to execute the automatic control mode. In other words, the lighting control unit 320 may adjust up or down the dimming, or maintain the dimming at a present level. To this end, the lighting control unit 320 may adjust the light output period of time of the light output unit 310 and the light cut-off period of time of the light output unit 310. In addition, the lighting control unit 320 may adjust current or voltage applied to the light output unit 310.

Finally, if the switch 350 is turned off, the lighting control unit 320 detects a switch-off state in step 663. In this case, the lighting control unit 320 terminates the automatic control mode in step 665 to terminate the operating procedure of the lighting device 300. In this case, the lighting control unit 320 may deactivate the lighting communication unit 340.

Meanwhile, if the off-state of the switch 350 is not detected in step 663, the light control unit 320 may repeat step 655 to step 663. In other words, the lighting control unit 320 may repeat step 655 to step 663 until the off-state of the switch 350 is detected in step 663.

FIG. 11 is a flowchart showing the operating procedure of the lighting gateway according to the first and second embodiments.

Referring to FIG. 11, according to present embodiments, the operating procedure of the lighting gateway 400 starts from that the gateway control unit 420 detects the reception of the present illuminance in step 671. In this case, if the present illuminance is received from the display device 200, the gateway control unit 420 may detect the reception of the present illuminance. In addition, if the present illuminance is received through the gateway communication unit 430, the gateway control unit 420 may detect the reception of the present illuminance.

Subsequently, the gateway control unit 420 controls the dimming of the lighting device 204 according to the present illuminance in step 673. In this case, the gateway control unit 420 may compare the present illuminance with previously-stored reference illuminance. In this case, the reference illuminance may be previously stored in the gateway memory 410. In addition, the gateway control unit 420 may determine if the dimming is adjusted up or down, or maintained. In addition, the gateway control unit 420 may request the lighting device 300 for the adjustment of the dimming. In this case, the gateway control unit 420 may request the lighting device 300 to adjust up or down or maintain the dimming. Further, the gateway control unit 420 may calculate the difference between the present illuminance and the reference illuminance and transmit the difference to the lighting device 300.

For example, if the present illuminance exceeds the reference illuminance, the gateway control unit 420 may make determination that the dimming must be adjusted down. Accordingly, the gateway control unit 420 may request the lighting device 300 to adjust down the dimming. Meanwhile, if the present illuminance is less than the reference illuminance, the gateway control unit 420 may make determination that the dimming must be adjusted up. Accordingly, the gateway control unit 420 may request the lighting device 300 to adjust up the dimming. Meanwhile, if the present illuminance is equal to the reference illuminance, the gateway control unit 420 may make determination that the dimming must be maintained. Accordingly, the gateway control unit 420 may request the lighting device 300 to maintain the dimming. In addition, the gateway control unit 420 may not request the lighting device 300 for the maintenance of the dimming.

Subsequently, if the dimming recovery is requested, the gateway control unit 420 detects the request for the dimming recovery in step 675. In this case, if the dimming recovery from the display device 200 is requested, the gateway control unit 420 may detect the request for the dimming recovery from the display device 200. If the dimming recovery is requested through the gateway communication unit 430, the gateway control unit 420 may detect the request for the dimming recovery.

Finally, the gateway control unit 232 terminates the operating procedure of the lighting gateway 400 by controlling the lighting device 300 to recover the dimming in step 677. In this case, the gateway control unit 420 controls the lighting device 300 to recover the dimming corresponding to the request from the display device 200. In this case, the gateway control unit 420 may determine if the dimming must be adjusted up, adjusted down, or maintained. In addition, the gateway control unit 420 may request the lighting device 300 to recover the dimming. In this case the gateway control unit 420 may request the lighting device 300 to adjust down, adjust up, or maintain the dimming.

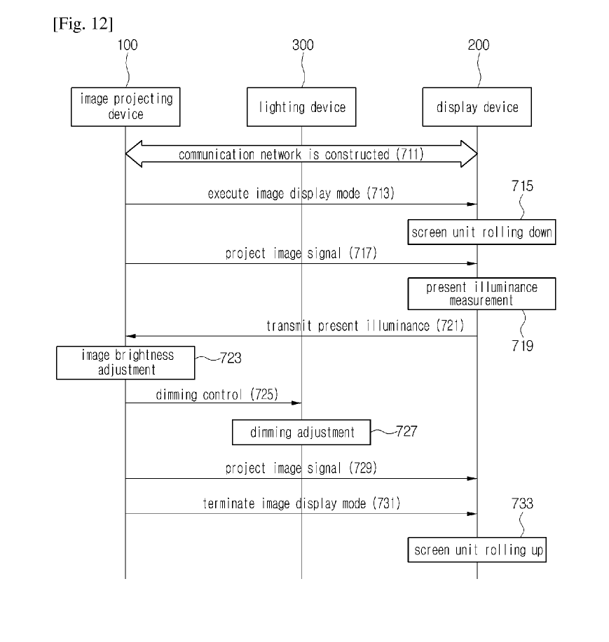

FIG. 12 is a flowchart showing the signal flow of the system for projecting the image according to the third embodiment.

Referring to FIG. 12, according to the present embodiments, the image projecting device 100, the display device 200, and the lighting device 300 construct a communication network in step 711. In this case, the communication network may include a wireless mesh network (WMN). Over the communication network, the image projecting device 100, the display device 200, and the lighting device 300 may make communication with each other through a short-range communication technology. In this case, the short-range communication technology includes Bluetooth, Zigbee, WiBro, WiMax, Wireless Local area Network (Wireless LAN), and an infrared communication technology. The light device 300 may be selected. In this case, the display device 200 may select the lighting device 300.

For example, the display device 200 may measure the first received signal strength from the lighting device 300 and the second received signal strength from the image projecting device 100. In addition, the display device 200 may compare the first received signal strength with the second received signal strength. In addition, if the first received signal strength is equal to or greater than the second received signal strength, the display device 200 may select the related lighting device 300. Accordingly, the display device 200 may determine that the related lighting device 300 is interposed between the display device 200 and the image projecting device 100. In addition, the display device 200 may notify the information of the related lighting device 300 to the image projecting device 100.

Next, the image projecting device 100 executes the image display mode of the display device 200 in step 713. In addition, the display device 200 rolls down the screen unit 210 in step 715. In other words, the display device 200 maintains the screen unit 210 in a rolling-down state at the image display mode.

Thereafter, the image projecting device 100 projects the image signal to the display device 200 in step 717. In this case, the image projecting device 100 projects the image signal with the preset image brightness. The display device 200 displays the image signal to the screen unit 210 as the screen unit 210 reflects the image signal. Thereafter, the display device 200 measures the preset illuminance in step 719. In this case, the display device 200 measures the present illuminance corresponding to the screen unit 210. In addition, the display device 200 transmits the present illuminance to the image projecting device 100 in step 721. In this case, the display device 200 may notify the information of the lighting device 300, which is interposed between the display device 200 and the image projecting device 100, to the image projecting device 100.

Subsequently, the image projecting device 100 controls the image brightness in step 723. In this case, the image projecting device 100 controls the image brightness according to the present illuminance. In this case, the image projecting device 100 may control the dimming in step 725. The image projecting device 100 may control the dimming according to the present illuminance. In other words, the image projecting device 100 may request the lighting device 300 to adjust the dimming. Accordingly, the lighting device 300 may adjust the dimming in step 727. In other words, the lighting device 300 may adjust the dimming under the control of the image projecting device 100.

Next, the image projecting device 100 projects the image signal onto the display device 200 in step 729. In this case, the image projecting device 100 projects the image signal with present image brightness.

Accordingly, in the system for projecting the image, the present illuminance is changed. In other words, as at least one of the image brightness of the image projecting device 100 and the dimming of the lighting device 300 is adjusted, the present illuminance is changed in the system for projecting the image.

Next, the image projecting device 100 terminates the image display mode of the display device 200 in step 731. In addition, the display device 200 rolls up the screen unit 210 in step 733. In other words, the display device 200 maintains the screen unit 210 at a rolling-up state in modes except for the image display mode.

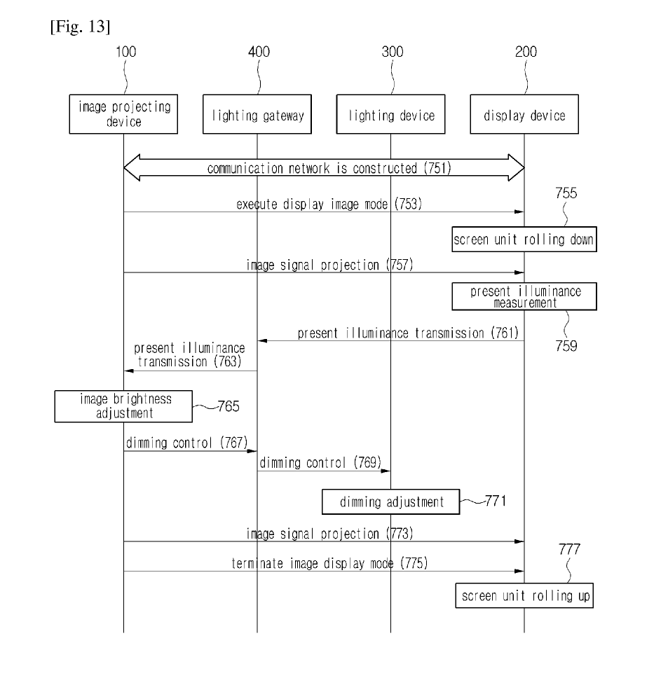

FIG. 13 is a flowchart showing the signal flow of the system for projecting the image according to the fourth embodiment.

Referring to FIG. 13, according to the present embodiments, the image projecting device 100, the display device 200, the lighting device 300, and the lighting gateway 400 construct a communication network in step 751. In this case, the communication network may include a wireless mesh network. Over the communication network, the image projecting device 100, the display device 200, the lighting device 300, and the lighting gateway 400 may make communication with each other through a short-range communication technology. In this case, the short-range communication technology includes Bluetooth, Zigbee, WiBro, WiMax, and Wireless Local area Network (Wireless LAN). In addition, the lighting device 300 may be selected. In this case, the display device 200 may select the lighting device 300.

For example, the display device 200 may measure the first received signal strength from the lighting device 300 and the second received signal strength from the lighting gateway 400. Next, the display device 200 may compare the first received signal strength with the second received signal strength. In addition, if the first received signal strength is equal to or greater than the second received signal strength, the display device 200 may select the related lighting device 300. Accordingly, the display device 200 may determine that the related lighting device 300 is interposed between the display device 200 and the lighting gateway 400. In addition, the display device 200 may notify the information of the related lighting device 300 to the image projecting device 100.

Next, the image projecting device 100 executes the image display mode of the display device 200 in step 753. In addition, the display device 200 rolls down the screen unit 210 in step 755. In other words, the display device 200 maintains the screen unit 2110 at a rolling-down state in the mage display mode.

Next, the image projecting device 100 projects the image signal on the display device 200 in step 757. In this case, the image projecting device 100 projects the image signal with the preset image brightness. In this case, the display device 200 displays the image signal on the screen unit 210 as the screen unit 210 reflects the image signal. Thereafter, the display device 200 measures the present illuminance in step 759. In this case, the display device 200 measures the present illuminance corresponding to the screen unit 210. In addition, the display device 200 transmits the present illuminance to the lighting gateway 400 in step 761. In addition, the lighting gateway 400 transmits the present illuminance to the image projecting device 100 in step 763. In this case, the information of the lighting device 300 interposed between the display device 200 and the lighting gateway 400 is notified to the image projecting device 100 together with the present illuminance.

Next, the image projecting device 100 controls the image brightness in step 765. In this case, the image projecting device 100 controls the image brightness according to the present illuminance. In this case, the image projecting device 100 may control the dimming in step 767. In this case, the image projecting device 100 may control the dimming according to the present illuminance. In other words, the image projecting device 100 may request the lighting gateway 400 to control the dimming. In addition, the lighting gateway 400 may control the dimming in step 769. In this case, the lighting gateway 400 may control the dimming according to the present illuminance. In other words, the lighting gateway 400 may request the lighting device 300 to adjust the dimming corresponding to the request of the image projecting device 100. Accordingly, the lighting device 300 may adjust the dimming in step 771. In other words, the lighting device 300 may adjust the dimming under the control of the image projecting device 100. Next, the image projecting device 100 projects the image signal onto the display device 200 in step 773. In this case, the image projecting device 100 projects the image signal with the present image brightness.

Accordingly, in the system for projecting the image, the present illuminance is changed. In other words, as at least one of the image brightness of the image projecting device 100 and the dimming of the lighting device 300 is adjusted, the present illuminance is changed in the system for projecting the image.

Next, the image projecting device 100 terminates the image display mode of the display device 220 in step 775. In addition, the display device 200 rolls up the screen unit 210 in step 777. In other words, the display device 200 maintains the screen unit 210 at a rolling-up state in modes except for the image display mode.

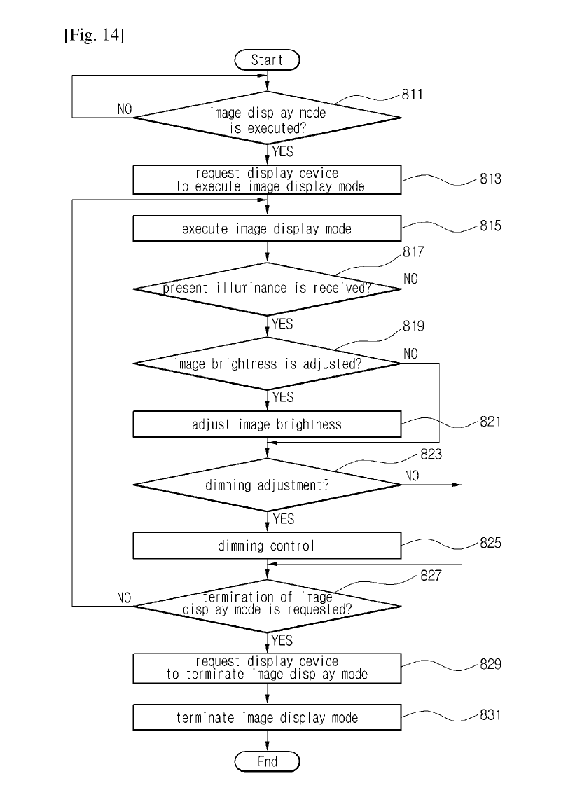

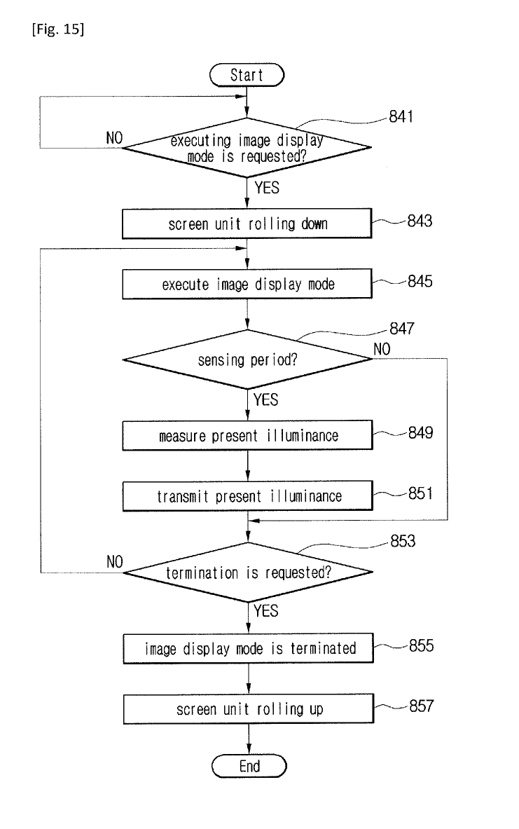

FIG. 14 is a flowchart showing the operating procedure of an image projecting device according to third and fourth embodiments.

Referring to FIG. 14, according to the present embodiments, the operating procedure of the image projecting device 100 starts from that the image control unit 150 detects the request for the execution of the image display mode in step 811. In this case, if the execution of the image display mode is requested through the user input unit 180, the image control unit 150 detects the request for the execution of the image display mode. In addition, the image control unit 150 executes the image display mode of the display device 200 in step 813. In this case, the image control unit 150 requests the display device 200 to execute the image display mode. The image control unit 150 may request the display device 200 to execute the image display mode through the short range communication unit 160.

Next, the image control unit 150 executes the image display mode in step 815. In this case, the image control unit 150 receives the image signal from an external device and processes the image signal. Then, the image control unit 150 projects the image signal to the display device 200. In this case, the image control unit 150 projects the image signal with the preset image brightness. Thereafter, if the present illuminance is received, the image control unit 150 detects the reception of the present illuminance in step 817. In this case, the image control unit 150 may receive the present illuminance from the display device 200. In addition, the image control unit 150 may receive the present illuminance through the short range communication unit 160.

Thereafter, the image control unit 150 determines if the image brightness must be adjusted according to the present illuminance in step 819. In this case, the image control unit 150 may compare the present illuminance with the previously-stored reference illuminance. In this case, the reference illuminance may be previously stored in the image memory 140. The reference illuminance may include lower and upper limits to ensure the definition of the image signal in the display device 200. For example, if the present illuminance is less than the lower limit of the reference illuminance or exceeds the upper limit of the reference illuminance, the image control unit 150 may determine that the image brightness must be adjusted. Meanwhile, if the present illuminance is equal to or greater than the lower limit, and equal to or less than the upper limit, the image control unit 150 may make determination that the image brightness must be maintained without being adjusted.

Subsequently, if the image control unit 150 makes determination that the image brightness must be adjusted in step 819, the image control unit 150 adjusts the image brightness in step 821. In this case, the image control unit 150 may adjust the quantity of light to be output together with the image signal. In addition, the image control unit 150 may adjust current or voltage applied to the image projecting unit 130. In this case, the image control unit 150 may adjust down the image brightness. For example, if the present illuminance is less than the lower limit, the image control unit 150 may adjust down the image brightness so that the image brightness is reduced to a darker degree. In addition, the image control unit 150 may adjust down the image brightness. For example, if the present illuminance exceeds the upper limit, the image control unit 150 may adjust up the image brightness so that the image brightness is increased to a lighter degree.

Meanwhile, in step 823, the image control unit 150 determines if the dimming must be adjusted according to the present illuminance. In this case, if the image control unit 150 determines that the image brightness may not be adjusted in step 819, the image control unit 150 may perform step 823. After adjusting the image brightness in step 821, the image control unit 150 may perform step 823. In this case, the image control unit 150 may compare the present illuminance with the reference illuminance. For example, if the present illuminance is less than the lower limit, or exceeds the upper limit, the image control unit 150 may determine that the dimming must be adjusted. Meanwhile, if the present illuminance is equal to or greater than the lower limit, and equal to or less than the upper limit, the image control unit 150 may determine that the dimming must be maintained without being adjusted.

Next, if the image control unit 150 determines that the dimming must be adjusted in step 823, the image control unit 150 controls the dimming in step 825. In this case, the image control unit 150 controls the lighting device 300 to adjust the dimming. In this case, the image control unit 150 may set an adjustment value of the dimming according to the present illuminance. In addition, the image control unit 150 may directly control the lighting device 300. In other words, the image control unit 150 may request the light device 300 to adjust the dimming. In this case, the image control unit 150 may transmit the adjustment value of the dimming to the lighting device 300. In addition, the image control unit 150 may control the lighting device 300 by using the lighting gateway 400. In other words, the image control unit 150 may request the lighting gateway 400 to control the dimming of the lighting device 300. In this case, the image control unit 150 may transmit the adjustment value of the dimming to the lighting gateway 400.

Finally, if the termination of the image display mode is requested, the image control unit 150 detects the termination of the image display mode in step 827. In this case, if the user input unit 160 requests the termination of the image display mode, the image control unit 150 may detect the request for the termination of the image display mode. If the image signal is not input through the image input unit 110, the image control unit 150 may determine this as the request for the termination of the image display mode. In addition, the image control unit 150 requests the display device 200 to terminate the image display mode in step 829. In this case, the image control unit 150 may request the display device 200 to terminate the image display mode through the short range communication unit 160. In addition, the image control unit 150 terminates the image display mode in step 831 to terminate the operating procedure of the image projecting device 100.

Meanwhile, if the request for the termination of the image display mode is not detected in step 827, the image control unit 150 repeats step 815 to step 827. In this case, the image control unit 150 repeats step 815 to step 827 until the request for the termination of the image display mode in step 827 is detected.

FIG. 15 is a flowchart showing the operating procedure of the display device according to the third and fourth embodiments.

Referring to FIG. 15, according to the present embodiments, the operating procedure of the display device 200 starts from that the display control unit 240 detects the request for the execution of the image display mode in step 841. In this case, if the execution of the image display mode is requested from the image projecting device 100, the display control unit 240 detects the request for the execution of the image display mode. If the execution of the image display mode is requested through the wireless communication unit 250, the display control unit 240 may detect the request for the execution of the image display mode. In addition, the display control unit 240 rolls down the screen unit 210 in step 843. Thereafter, the display control unit 240 executes the image display mode in step 845. In this case, the display control unit 240 displays the image signal of the image projecting device 100 onto the screen unit 210.

Subsequently, if the sensing period arrives, the display control unit 240 detects the arrival of the sensing period in step 847. In this case, the sensing period may be previously stored in the display memory 230. The sensing period represents a predetermined period of time periodically occurring from a time point of executing the image display mode. In addition, the display control unit 240 measures the present illuminance in step 849. In this case, the display control unit 240 measures the present illuminance by controlling the illuminance sensor 220.

Subsequently, the display control unit 240 transmits the present illuminance to the image projecting device in step 851. In this case, the display control unit 240 may directly transmit the present illuminance to the image projecting device 100. In addition, the display control unit 240 may transmit the present illuminance to the image projecting device 100 by using the lighting gateway 400. In addition, the display control unit 240 may transmit the present illuminance through the wireless communication unit 250.

Finally, if the termination of the image display mode is requested, the display control unit 240 detects the request for the termination of the image display mode in step 853. In this case, if the termination of the image display mode is requested from the image projecting device 100, the display control unit 240 detects the request for the termination of the image display mode. In addition, if the termination of the image display mode is requested from the wireless communication unit 250, the display control unit 240 may detect the request for the termination of the image display mode. In addition, the display control unit 240 rolls up the screen unit 210 in step 855. Thereafter, the display control unit 240 terminates the image display mode in step 857 to terminate the operating procedure of the display device 200.

Meanwhile, if the request for the termination of the image display mode is not detected in step 853, the display control unit 240 repeats step 845 to step 853. In other words, the display control unit 240 repeats step 845 to step 853 until the request for the termination of the image display mode is detected in step 853.

FIG. 16 is a flowchart showing the operating procedure of the lighting device according to the third and fourth embodiments.

Referring to FIG. 16, according to the present embodiments, the operating procedure of the lighting device 300 starts from that the lighting control unit 320 detects the on-state of the switch 350. In other words, if the switch 350 is turned on, the lighting control unit 320 detects the on-state of the switch 350. In addition, the lighting control unit 320 executes an automatic control mode in step 863. In this case, the lighting control unit 320 may activate the lighting communication unit 340.

Subsequently, if the adjustment of the dimming is requested, the lighting control unit 320 detects the request for the adjustment of the dimming in step 865. In this case, if the adjustment of the dimming is requested from the image projecting device 100 or the lighting gateway 400, the lighting control unit 320 may detect the request for the adjustment of the dimming. In addition, if the adjustment of the dimming is requested through the lighting communication unit 340, the lighting control unit 320 may detect the request for the adjustment of the dimming. Thereafter, the lighting control unit 320 adjusts the dimming in step 867. The lighting control unit 320 may adjust up or down the dimming or maintain the dimming. To this end, the lighting control unit 320 may adjust the light output period of time of the light output unit 310 and the light cut-off period of time of the light output unit 310. In addition, the lighting control unit 320 may adjust current or voltage applied to the light output unit 310.

Finally, if the switch 350 is turned off, the lighting control unit 320 detects the off-state of the switch 350 in step 869. In this case, the lighting control unit 320 terminates the automatic control mode in step 871 to terminate the operating procedure of the lighting device 300. In this case, the lighting control unit 320 may deactivate the lighting communication unit 340.

Meanwhile, if the off-state of the switch 350 is not detected in step 869, the lighting control unit 320 may repeat step 863 to step 869. In other words, the lighting control unit 320 may repeat step 863 to step 869 until the off-state of the switch 350 is detected in step 869.

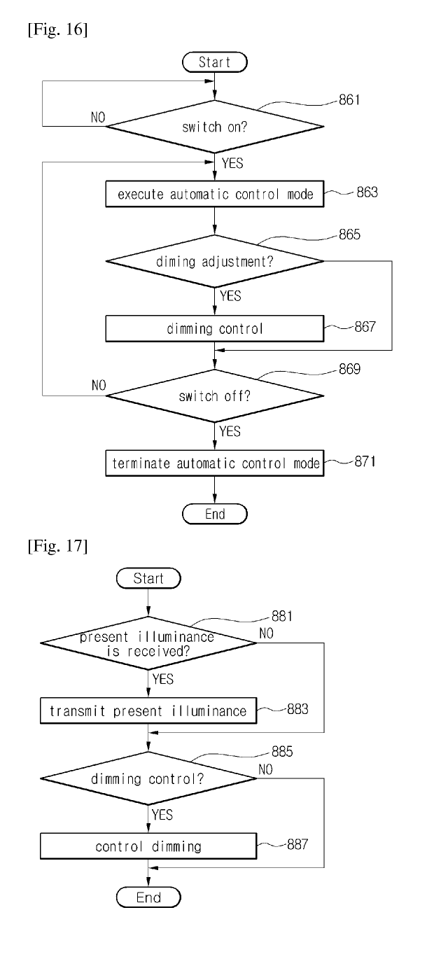

FIG. 17 is a flowchart showing the operating procedure of the lighting gateway according to the third and fourth embodiments.

Referring to FIG. 17, according to the present embodiments, the operating procedure of the lighting gateway 400 starts from that the gateway control unit 420 detects the reception of the present illuminance in step 881. In this case, if the present illuminance is received from the display device 200, the gateway control unit 420 may detect the reception of the present illuminance from the display device 200. If the present illuminance is received from the gateway communication unit 430, the gateway control unit 420 may detect the reception of the present illuminance from the gateway communication unit 430. Thereafter, the gateway control unit 420 transmits the present illuminance to the image projecting device 100 in step 883. In this case, the gateway control unit 420 transmits the present illuminance through the gateway communication unit 430. In addition, the gateway control unit 420 may store the present illuminance in the gateway memory 410.

Subsequently, if the dimming control is requested, the gateway control unit 420 detects the request for the dimming control in step 885. If the dimming control is requested from the image projecting device 100, the gateway control unit 420 may detect the request for the dimming control. In addition, if the dimming control is requested through the gateway communication unit 430, the gateway control unit 420 may detect the request for the dimming control through the gateway communication unit 430.

Finally, the gateway control unit 420 controls the dimming in step 887 to terminate the operating procedure of the lighting gateway 400. In this case, the gateway control unit 420 controls the lighting device 300 to adjust the dimming. In this case, the gateway control unit 420 may determine the adjustment value of the dimming according to the present illuminance. In addition, the gateway control unit 420 requests the lighting device 300 for the adjustment of the dimming. In this case, the gateway control unit 420 may transmit the adjustment value of the dimming to the lighting device 300. In addition, the gateway control unit 420 requests the lighting device 300 to adjust the dimming by using the gateway communication unit 430.

Meanwhile, the previous embodiments disclose that the image projecting device 100 directly executes or terminates the image display mode of the display device 200, but the embodiment is not limited thereto. In other words, although the image projecting device 100 executes or terminates the image display mode of the display device 200 by using the lighting gateway 400, the disclosure can be realized.

For example, when the image display mode is executed, the image projecting device 100 may request the lighting gateway 400 to execute the image display mode of the display device 200. In addition, the lighting gateway 400 may request the display device 200 to execute the image display mode corresponding to the request of the image projecting device. In addition, the display device 200 may execute the image display mode corresponding to the request of the lighting gateway 400.

Similarly, when the image display mode is terminated, the image projecting device 100 may request the lighting gateway 400 to terminate the image display mode of the display device 200. In addition, the lighting gateway 400 may request the display device 200 to terminate the image display mode corresponding to the request of the image projecting device 100. In addition, the display device 200 may terminate the image display mode corresponding to the request of the lighting gateway 400.

Although not shown, before terminating the image display mode, the image projecting device 100 may recover the dimming state of the lighting device 300 to the previous state of the adjustment of the dimming. In other words, if the termination of the image display mode is requested, the image projecting device 100 may control the dimming recovery of the lighting device 300 and terminate the image display mode. In this case, the image projecting device 100 may directly request the lighting device 300 to recover the dimming state. In addition, the image projecting device 100 may request the lighting device 300 to recover the dimming by using the lighting gateway 400. Accordingly, the lighting device 300 may recover the dimming under the control of the image projecting device 100 or the lighting gateway 400.

According to the present invention, the system for projecting the image can easily control the surrounding illuminance. In other words, the lighting device 300 can adjust the dimming corresponding to the present illuminance or can adjust the image brightness corresponding to the present illuminance. Accordingly, in the system for projecting the image, the surrounding illuminance can be changed according to the dimming of the lighting device 300 or the image brightness of the image projecting device 100. Accordingly, in the system for projecting the image, the surrounding illuminance can be finely adjusted.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. A system for projecting an image, the system comprising:
an image projecting device to project an image signal;
a display device comprising a screen unit to display the image signal thereon, an illuminance sensor to measure a present illuminance, and a first communication unit to transmit the present illuminance; and
a lighting device to adjust dimming according to the present illuminance.

2. The system of claim 1, wherein the image projecting device comprises:
an image projecting unit to project the image signal with a preset brightness;
a second communication unit to receive the present illuminance; and
a brightness adjusting unit to adjust the brightness according to the present illuminance.

3. The system of claim 1, wherein the display device further comprises a driving unit to drive the screen unit according to a request of the image projecting device.

4. The system of claim 3, wherein the image projecting device requests the display device to drive the screen unit when executing an image display mode to project the image signal, and requests the display device to terminate the driving of the screen unit when terminating the image display mode.

5. The system of claim 1, wherein the lighting device comprises a third communication unit to receive the present illuminance from the display device or to receive a dimming control signal according to the present illuminance from the image projecting device.

6. The system of claim 1, further comprising a lighting gateway to relay communication between at least two of the image projecting device, the display device, and the lighting device.

7. The system of claim 1, wherein the lighting device recovers the adjusted dimming when terminating the image display mode.

8. A method of projecting an image, the method comprising:
projecting an image signal on a display device by an image projecting device;
measuring a present illuminance by the display device;
transmitting the present illuminance by the display device; and
adjusting dimming according to the present illuminance by a lighting device.

9. The method of claim 8, further comprising:
receiving the present illuminance by the image projecting device; and
adjusting brightness of the image signal according to the present illuminance by the image projecting device.

10. The method of claim 9, wherein the display device comprises a screen unit to display the image signal thereon, and
wherein the projecting of the image signal comprises:
requesting the display device to drive the screen unit by the image projecting device;
driving the screen unit by the display device; and
projecting the image signal on the display device by the image projecting device.

11. The method of claim 10, further comprising:
requesting the display device to terminate the driving of the screen unit by the image projecting device if the projecting of the image signal is terminated; and
terminating the driving of the screen unit by the display device.

12. The method of claim 8, wherein the adjusting of the dimming according to the present illuminance comprises:
receiving the present illuminance by the lighting device; and
adjusting the dimming according to the present illuminance by the lighting device.

13. The method of claim 8, wherein the adjusting of the dimming comprises:
receiving the present illuminance by the image projecting device;
controlling the lighting device according to the present illuminance by the image projecting device; and
adjusting the dimming by the lighting device under a control of the image projecting device.

14. The method of claim 8, wherein a lighting gateway relays communication between at least two of the image projecting device, the display device, and the lighting device.

15. The method of claim 8, further comprising recovering the adjusted dimming by the lighting device if the projecting of the image signal is terminated by the image projecting device.
